(19) United States
(12) Patent Application Publication
(10) Pub. No.: US 2007/0246523 A1
(43) Pub. Date: Oct. 25, 2007

(54) Metered mail and online postage tracking

(76) Inventor: Gary C. Reblin, Fall Church, VA (US)

Correspondence Address: FINNEGAN, HENDERSON, FARABOW,;GARRETT & DUNNER, L.L.P., 1300 I Street, N.W., Washington, DC, 20005, US

(21) Appl. No.: 10/953,275

(22) Filed: Sep. 30, 2004

Related U.S. Application Data
(60) Provisional application No. 60/549,928, filed on Mar. 5, 2004.

(51) Int. Cl. G06F 17/00

(52) U.S. Cl. 235/375

(57) ABSTRACT

A system and method for providing passive tracking of delivery items using a unique identifier, such as a metered mark with a two dimensional barcode. The customer may access a database that is updated with status information.

### RELATED APPLICATIONS

This application is related to and claims priority of U.S. Provisional Application No. 60/549,928 entitled “Metered Mail Tracking with Two Dimensional Bar Code” filed Mar. 5, 2004, which is incorporated herein by reference in its entirety.

### DESCRIPTION

1. Technical Field

This invention relates generally to a system and method for tracking delivery items, and more particularly, to a system and method for providing passive tracking services for delivery items using a unique identifier.

2. Background

Presently, customers of delivery service providers, such as the United States Postal Service (USPS), United Parcel Service, Federal Express, and other ship delivery items using printing machines or systems, e.g., postage meters, that allow customers to print delivery fees directly onto a delivery item, or onto a label that is affixed to the delivery item.

Customers also ship delivery items using delivery fees purchased and generated through the Internet (online postage). Online postage allows customers to pay delivery fees online, print the delivery fees onto a label, and attach the label to the delivery item.

Postage meters and online postage allow customers to track the costs of delivery fees and to pay for extra services associated with mailing. Such extra services include, for example, Certified Mail, Business Reply Mail, Address Change Service, Return Receipt Product, Electronic Return Receipt Product, etc.

Postage meters and online postage also allow customers to choose between a variety of delivery services, for example First Class Mail, Priority Mail, Express Mail, Package Services, International Mail, Presorted First Class Mail Services, etc.

Postage meters preferably produce two dimensional barcodes that can uniquely identify each piece of mail. Similarly, a customer purchasing online postage from a delivery provider preferably receives a two dimensional barcode on the prepaid delivery label he generates. Two dimensional barcodes utilize both the height and the width of the bars to encode data, thereby allowing a greater amount of data to be encoded. Embedded within the barcode is identifying information, such as an indication of the postal meter generating the barcode and the owner of the postage meter. When using online postage services, the identifying information may include information identifying the customer, such as a username, user identification number, or account number. A unique identifier can be created for each delivery item.

During processing for delivery, a number of different types of automated equipment may handle the delivery item. The automated equipment includes a number of commercially available machines, such as a delivery barcode sorter, a carrier sequence barcode sorter, and other barcode equipment. The automated equipment also may include optical character recognition (OCR) equipment. This equipment reads the unique identifier for each delivery item in order to properly process the delivery item.

Despite the fact that so many devices read the unique identifier at their given locations, if the customer desires to know the delivery status or present location of the delivery item, that information is not readily available for the customer. Thus, it is desirable to provide a tracking service for metered delivery items and/or online postage delivery items so that information regarding the delivery processing status is readily available to the customer.

### SUMMARY

Consistent with the invention, systems and methods for tracking metered delivery items or online postage delivery items include passively tracking a unique identifier generated for each delivery item.

Also included is a system and method for tracking metered delivery items or online postage delivery items, wherein the unique identifier is included in the metered mark.

It is to be understood that both the foregoing general description and the following detailed description are exemplary and explanatory only and are not restrictive of the appended claims.

The accompanying drawings, which are incorporated in and constitutes a part of this specification, illustrate embodiments and together with the description, serve to explain the principles of the invention.

### BRIEF DESCRIPTION OF THE DRAWINGS

FIG. 1 is a flowchart illustrating a method consistent with the invention for tracking metered delivery items; and

FIG. 2 illustrates an embodiment of a delivery item including a metered mark comprising a unique identifier.

### DESCRIPTION OF THE EMBODIMENTS

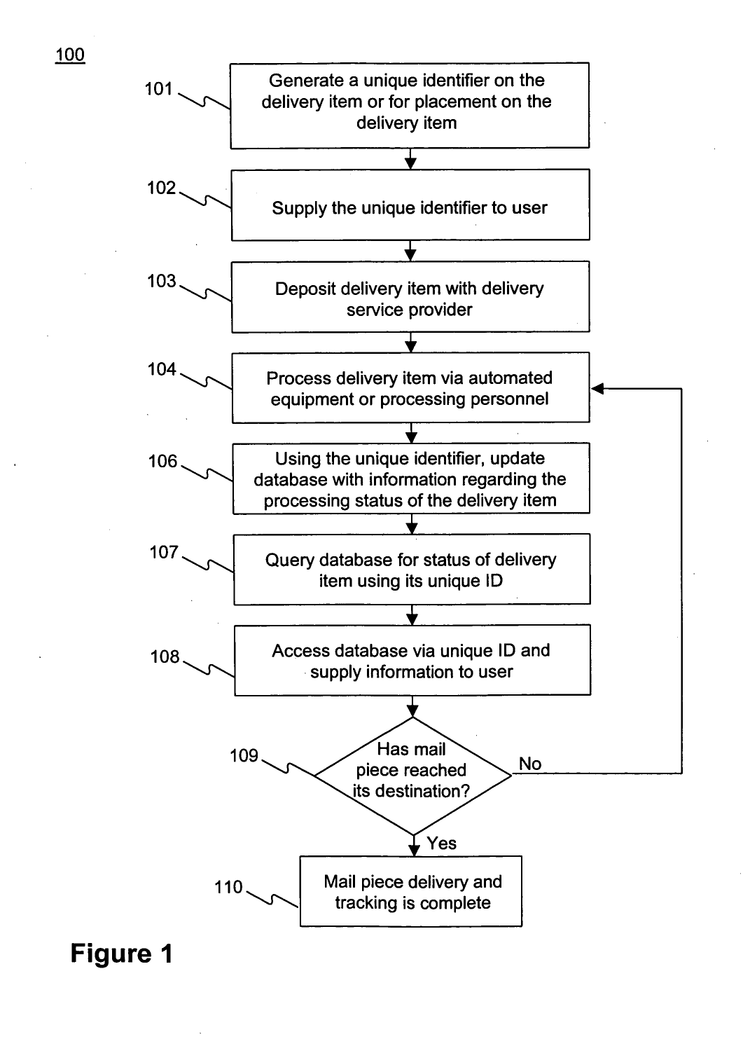

Referring now to the drawings, FIG. 1 is a flowchart of a method 100 showing the tasks and steps for tracking delivery items such as mail pieces.

Method 100 begins at stage 101 where a unique identifier (unique ID) for the delivery item is created. The unique ID may be, for example, a two dimensional barcode that is generated on the delivery item. The unique ID may be generated by a postal meter and printed directly on the delivery item. Alternatively, the unique ID can be printed on a label that is affixed to the delivery item.

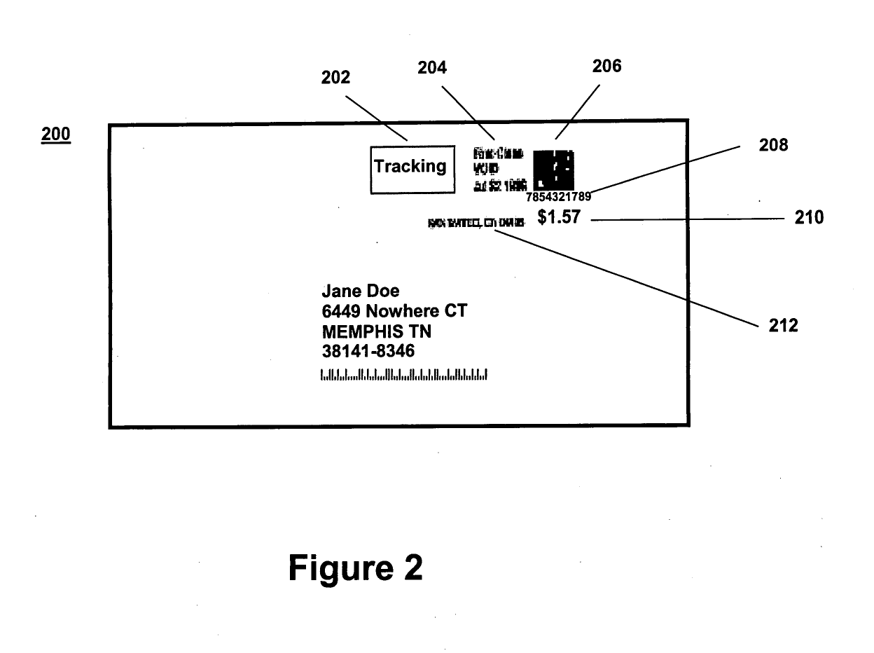

FIG. 2 illustrates an example of a delivery item, in the form of a mailpiece 200, consistent with the present invention. This exemplary embodiment includes a metered mark having a tracking designator 202 that informs the delivery service provider, the sender, and the receiver that the delivery item is being tracked. The type of mail service 204, such as First Class, may also be indicated on the envelope, along with the date the metered mark was created. A two dimensional barcode 206 includes the delivery item's unique ID, which may also be displayed in human-readable form at 208. The delivery item may also display the delivery fee 210, along with the name of the post office and its ZIP Code at 212.

Referring back to FIG. 1, at stage 102, a human-readable form of the unique ID is supplied to the customer. This may occur simultaneously with step 101 or after step 101. For example, the unique ID may be printed on a receipt that is given to the customer when the customer goes to a provider facility to mail the delivery item and the postage meter label is generated at the provider facility. Alternatively, the unique ID may be displayed to the customer when a home postage meter is used by the customer to print a postage label. When paying delivery fees online, the customer may receive the unique ID electronically via email, a screen display, or an automatically-generated printout.

At stage 103, the delivery service provider receives a delivery item with a unique ID. The unique ID allows tracking of the delivery item during processing (as explained below) through a distribution network operated by a delivery service provider, such as the USPS. The distribution network may include any or all of the processing centers of the delivery provider that handle outgoing and incoming mail.

At stage 104, the delivery item is processed by the delivery service provider's automated equipment and/or its processing personnel. Typically, a series of automated equipment and/or personnel at one or more locations perform designated tasks to route the delivery item until it is delivered to its destination.

At stage 106, when the delivery item is handled by automated equipment or mail processing personnel, the unique ID is read and associated with other data, such as location of the processing stage and time. Preferably, the reading takes place by an automated scan of the unique ID on the delivery item. A database is then updated with the unique ID and associated data for the delivery item. Database updates may occur at each processing point, or at only selected points. The database contains information on a plurality of delivery items handled by the delivery service provider. Therefore, the database can be accessed to provide the location or processing status of the delivery item by entering the delivery item's unique ID.

This method of tracking the delivery item is a passive method that does not require the use of steps or equipment beyond that which is already utilized in delivery item processing. Additional barcode scanners and scanning steps need not be added to the existing delivery process.

At stage 107, a delivery item status request, including the unique ID, is received from the customer (e.g., a sender or receiver of the delivery item). The request may be received via website, e-mail, phone, or other appropriate means. In response to the request, at stage 108, the database is accessed by a processor and status information regarding the delivery item is provided to the customer via a transmitter. Alternatively, the status of the delivery item can be transmitted to a customer at predetermined intervals, without the customer having to request the information. The status information may include information identifying a piece of equipment that processed the delivery item and its location, indicating that the delivery item is in transit (e.g., on a plane to a destination processing center), or identifying that the delivery item is ready for delivery (e.g., a mail carrier is in the process of delivering the delivery item). Preferably, the customer may access the database at any time during method 100.

At stage 109, if the delivery item needs to undergo further processing (i.e., it has not yet been delivered), method 100 returns to stage 104 and performs the steps as described above. If no further processing is required for delivery of the item, delivery and tracking are complete at stage 110.

In an alternative embodiment, a container that carries delivery items may additionally or alternatively be tracked. For example, using the system and method outlined above, the customer mails a delivery item having a unique ID. Once the customer gives the delivery item to a processing center for delivery, the delivery item may be placed into a container that carries a plurality of delivery items. The container has its own unique ID such as a two dimensional barcode or an RFID. Personnel at the processing center associate the unique ID on the delivery item with the unique ID on the container. The delivery item may then be tracked using the container's unique ID instead of the delivery item's own unique ID. Preferably, the customer continues to track the delivery item by its unique ID and never needs to be concerned about the container's unique ID. For the processing center, this allows for efficient use of resources in tracking the delivery item, while allowing the customer to track the delivery item using the delivery item's unique ID.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A system for passively tracking a delivery item, comprising:
a unique identifier affixed to the delivery item;
processing equipment that reads the unique identifier as the delivery item is processed and generates information regarding a processing status of the delivery item;
a database that stores the information regarding the processing status of the delivery item along with the delivery item unique identifier;
a processor that receives a customer query including the unique identifier and queries the database to retrieve the processing status of the delivery item; and
a transmitter to send the processing status of the delivery item to the customer.

2. The system of claim 1, wherein the unique identifier is created by a postage meter.

3. The system of claim 1, wherein the unique identifier is created by the user when the user purchases online postage.

4. The system of claim 1, wherein the unique identifier is a barcode.

5. The system of claim 1, wherein the unique identifier is a two dimensional barcode.

6. A method for passively tracking a delivery item, comprising the steps of:
generating a unique identifier for the delivery item;
affixing the unique identifier to the delivery item;
processing the delivery item with mail processing equipment that reads the unique identifier as the delivery item is processed and generates information regarding a processing status of the delivery item;
updating a database that stores the information regarding the processing status of the delivery item along with the delivery item unique identifier;
supplying the unique identifier of the delivery item to a customer;
receiving a query from the customer including the unique identifier; and
supplying the processing status of the delivery item to the customer.

7. The method of claim 6, wherein the unique identifier is generated by a postage meter.

8. The system of claim 6, wherein the unique identifier is generated by the user when the user purchases online postage.

9. The system of claim 6, wherein the unique identifier is a barcode.

10. The system of claim 6, wherein the unique identifier is a two dimensional barcode.

11. A system for passively tracking a delivery item, comprising:
a delivery item having a unique identifier;
a container having a unique identifier into which the delivery item is placed;
processing equipment that reads the unique identifier of the container and generates information regarding a processing status of the container;
a database that associates the delivery item unique identifier with the container unique identifier, and stores the information regarding a processing status of the container;
a processor that receives a customer query including the unique identifier of the delivery item and queries the database to retrieve the processing status of the delivery item; and
a transmitter to send the processing status of the delivery item to the customer.

12. The system of claim 11, wherein the container unique identifier is a two dimensional barcode.

13. The system of claim 11, wherein the container unique identifier includes a radio-frequency identification.
